(19) United States
(12) Patent Application Publication
(10) Pub. No.: US 2022/0099010 A1
(43) Pub. Date: Mar. 31, 2022

(54) SELF-ADAPTIVE OIL SPRAYING CONTROL SYSTEM AND METHOD FOR BIODIESEL ENGINE

(71) Applicant: TONGJI UNIVERSITY, Shanghai (CN)

(72) Inventors: Diming Lou, Shanghai (CN); Yinghua Zhao, Shanghai (CN); Piqiang Tan, Shanghai (CN); Yunhua Zhang, Shanghai (CN); Liang Fang, Shanghai (CN); Zhiyuan Hu, Shanghai (CN)

(73) Assignee: TONGJI UNIVERSITY, Shanghai (CN)

(21) Appl. No.: 17/214,948

(22) Filed: Mar. 29, 2021

(30) Foreign Application Priority Data
Sep. 27, 2020 (CN) 202011036263.X

(51) Int. Cl. F01N 3/20; F01N 11/00

(52) U.S. Cl. CPC F01N 3/208; F01N 11/00; F01N 2560/026; F01N 2610/146; F01N 2900/0408; F01N 2900/1614; F01N 2900/0402

(57) ABSTRACT

The disclosure relates to a self-adaptive oil spraying control system and method for a biodiesel engine. The control system includes an exhaust pipe, a gas sensor, a control module and an oil sprayer, wherein the exhaust pipe is connected to the oil sprayer, the gas sensor is mounted in the exhaust pipe, and the gas sensor and the oil sprayer are connected to the control module respectively. According to the control method, a main spray advance angle of the engine is subjected to closed-loop control directly through comparison between an idling steady state NOₓ emission signal and an idling steady state NOₓ emission value of pure diesel when the engine uses the biodiesel, so that emission of NOₓ in the exhaust is reduced. Compared with the prior art, the disclosure has the advantages of no need of detecting a biodiesel ratio, high efficiency, good effect and the like.

### CROSS-REFERENCE TO RELATED APPLICATION

This application claims the priority benefit of China application serial no. 202011036263.X, filed on Sep. 27, 2020. The entirety of the above-mentioned patent application is hereby incorporated by reference herein and made a part of this specification.

### FIELD OF TECHNOLOGY

The disclosure relates to the technical field of biodiesel spraying control, and in particular, to a self-adaptive oil spraying control system and method for a biodiesel engine.

### BACKGROUND

Compared with the traditional diesel engine, the biodiesel engine has the characteristic of high NOₓ emission. Therefore, how to reduce NOₓ emission is the research focus of the biodiesel engine. The existing patent CN201610826273.0 improves the preparation process of the biodiesel to obtain modified biodiesel, thereby reducing NOₓ emission. The existing patent CN201810091332.3 improves the proportion and preparation method of the biodiesel so as to greatly reduce harmful components in engine tail gas. It may be seen that the above patents reduce the NOₓ emission of the biodiesel engine by directly improving fuel. However, at present, there are few technologies to solve the problem of high NOₓ emission of the biodiesel engine by directly using the internal purification technology of the biodiesel engine. The existing patent CN201010191235.5 determines the proportion of the biodiesel by measuring the relative dielectric constant value of the biodiesel mixed fuel with different mixing ratios, and then studies how to improve the usability of the biodiesel engine.

It can be seen that in the prior art, reducing the high NOₓ emission of the biodiesel engine is all studied on the basis of the biodiesel itself, and there is no control system and method for the engine to reduce the NOₓ emission of the biodiesel engine.

### SUMMARY

An objective of the disclosure is to provide a self-adaptive oil spraying control system and method for a biodiesel engine, which do not need to detect the proportion of the biodiesel and have high efficiency and good effect so as to overcome the defects in the prior art.

The objective of the disclosure may be achieved by the following technical solutions:

a self-adaptive oil spraying control system for a biodiesel engine includes an exhaust pipe, a gas sensor, a control module and an oil sprayer, wherein the exhaust pipe is connected to the oil sprayer; the gas sensor is mounted in the exhaust pipe; the gas sensor and the oil sprayer are connected to the control module respectively; and a self-adaptive oil spraying control program is embedded in the control module.

Preferably, there are a plurality of oil sprayers; and the plurality of oil sprayers are connected to the control module respectively.

Preferably, the temperature sensor is a NOₓ sensor.

Preferably, the control module is a vehicle-mounted electronic control unit (ECU).

A self-adaptive oil spraying control method for a biodiesel engine applied to the oil spraying control system includes:

Step 1: acquiring a NOₓ emission standard value;

Step 2: acquiring a NOₓ steady state emission value in real time;

Step 3: determining whether the NOₓ steady emission value acquired in Step 2 is greater than the NOₓ emission standard value, if yes, performing Step 6, otherwise, performing step 7;

Step 4: performing self-adaptive control on main spray timing according to a difference value between the NOₓ steady state emission value and the NOₓ emission standard value until the difference value between the NOₓ steady state emission value and the NOₓ emission standard value is zero, and then performing Step 5;

Step 5: determining whether a delay angle of the main spray timing is greater than zero, if yes, performing Step 6, otherwise, performing Step 7;

Step 6: adjusting oil spraying map in the ECU and then returning to Step 3; and

Step 7: completing self-adaptive oil spraying control.

Preferably, the Step 1 is as follows:

starting the engine added with pure diesel, controlling the engine to be stable under the working condition of idling, acquiring an output signal of a NOₓ sensor by the control module, and acquiring a NOₓ steady state emission value to serve as a NOₓ emission standard value.

Preferably, the Step 2 is as follows:

starting the engine added with biodiesel in any proportion, controlling the engine to be stable under the working condition of idling, acquiring an output signal of a NOₓ sensor by the control module, and acquiring a NOₓ steady state emission value in real time.

Preferably, self-adaptive control in the Step 4 is closed loop feedback control.

More preferably, a transfer function of the closed loop feedback control is as follows:

$${G}_{1} ( s ) = \frac{R ( s )}{Y ( s )} = \frac{{K}_{p} + \frac{{K}_{i}}{s} + {K}_{d} s}{H ( s )}$$

wherein H(s) is a feedback control function, Kₚ is a proportional constant, Kᵢ is an integration constant, and K_{d} is a differential constant.

Preferably, the Step 6 is as follows:

if the delay angle of the main spray timing is greater than zero, the oil spraying map in the ECU is adjusted, and all the main spray timing in the oil spraying map is delayed according to the delay angle of the main spray timing.

Compared with the prior art, the disclosure has the following advantages:

the disclosure provides a self-adaptive oil spraying control system and method for a biodiesel engine, which perform closed loop control on the main spray advance angle of the engine by directly comparing an idling steady state NOₓ emission signal and an idling steady state NOₓ emission value of pure diesel instead of detecting the proportion of the biodiesel outside or inside the engine, thereby reducing the NOₓ emission in the exhaust. By taking the engine added with B20 biodiesel as an example, the NOₓ emission of the engine can be reduced by about 15% and 10% respectively under the conditions normal rotating speed, medium load and external characteristic while the engine power is ensured, so that higher efficiency is achieved, and work stability and emission reduction of the biodiesel engine are ensured.

### BRIEF DESCRIPTION OF THE DRAWINGS

FIG. 1 is a self-adaptive oil spraying control system for a biodiesel engine according to the disclosure.

FIG. 2 is a schematic flowchart of a self-adaptive oil spraying control method for a biodiesel engine according to the disclosure.

FIG. 3 is a closed loop feed control according to the disclosure.

FIG. 4 is a PID controller according to the disclosure.

The reference numerals in the drawings are as follows:

Exhaust pipe, 2. Gas sensor, 3, control module, 4. Oil sprayer.

### DESCRIPTION OF THE EMBODIMENTS

The technical solutions in embodiments of the disclosure are described clearly and completely below with reference to the accompanying drawings in the embodiments of the disclosure. Obviously, the described embodiments are merely a part of embodiments of the disclosure and not all the embodiments. Based on the embodiments of the disclosure, all of other embodiments obtained by a person of ordinary skill in the art without any creative effort shall belong to the protection scope of the disclosure.

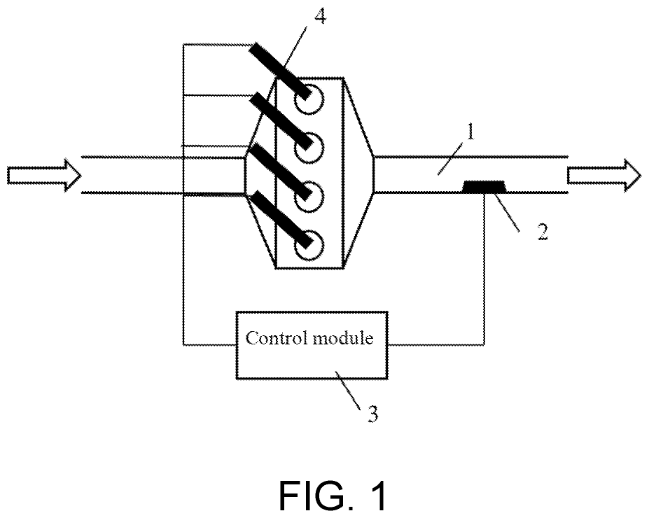

A self-adaptive oil spraying control system for a biodiesel engine has a structure shown in FIG. 1 and includes an exhaust pipe 1, a gas sensor 2, a control module 3 and an oil sprayer 4, wherein the exhaust pipe 1 is connected to the oil sprayer 4, the gas sensor 2 is mounted in the exhaust pipe 1, the gas sensor 2 and the oil sprayer 4 are connected to the control module 3 respectively, and a self-adaptive oil spraying control program is embedded in the control module 3.

There is a plurality of oil sprayers 4, and the plurality of oil sprayers 4 are connected to the control module 3 respectively; the gas sensor 2 is a NOₓ sensor; and the control module 3 is a vehicle-mounted ECU.

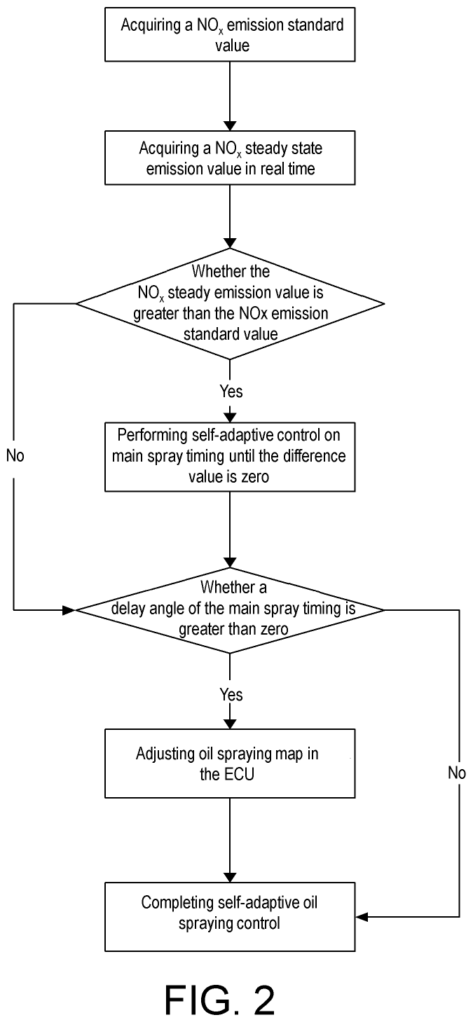

A self-adaptive oil spraying control method for a biodiesel engine applied to the oil spraying control system, of which the schematic flowchart is as shown in FIG. 2, includes:

Step 1: a NOₓ emission standard value is acquired, which is as follows:

the engine added with pure diesel is started, the engine is controlled to be stable under the working condition of idling, an output signal of a NOₓ sensor is acquired by the control module, and a NOₓ steady state emission value is acquired to serve as a NOₓ emission standard value.

Step 2: a NOₓ steady state emission value is acquired in real time, which is as follows:

the engine added with biodiesel in any proportion is started, the engine is controlled to be stable under the working condition of idling, an output signal of a NOₓ sensor is acquired by the control module, and a NOₓ steady state emission value is acquired in real time.

Step 3: determining whether the NOₓ steady emission value acquired in Step 2 is greater than the NOₓ emission standard value, if yes, performing Step 6, otherwise, performing Step 7;

Step 4: main spray timing is subjected to self-adaptive control according to a difference value between the NOₓ steady state emission value and the NOₓ emission standard value until the difference value between the NOₓ steady state emission value and the NOₓ emission standard value is zero, and then Step 5 is performed.

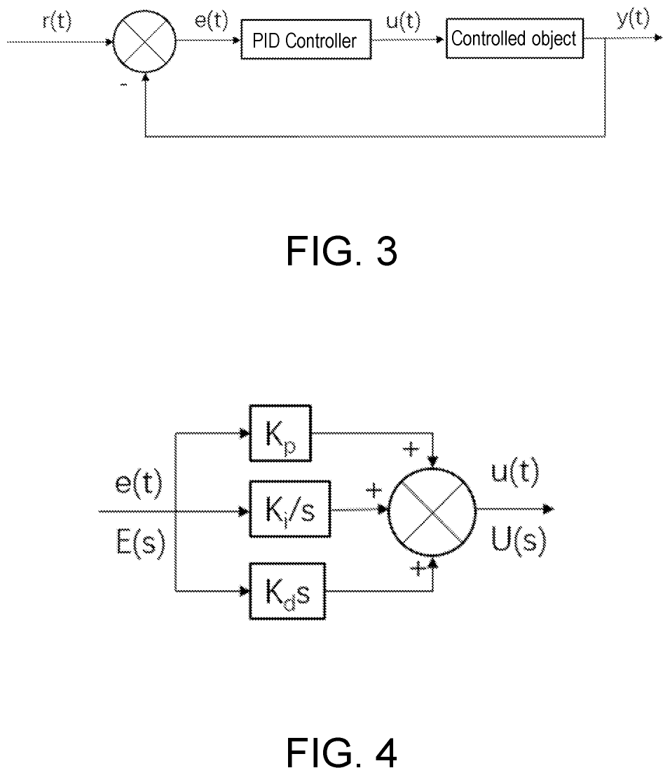

As shown in FIG. 3, the closed loop feedback control in the embodiment adopts PID control. According to the error of the system, the PID controller calculates the control quantity by using proportion, integration and differential for control. The PID control principle is as shown in FIG. 4, wherein r(t) is input quantity, y(t) is output quantity, e(t) is deviation value, u(t) is output quantity of PID controller, and the controlled object is main spray timing. For this example, r(t) represents NOₓ emission standard value, y(t) represents NOₓ steady state emission value, and e(t) is deviation value.

A transfer function of the PID controller is:

$$G ( s ) = \frac{U ( s )}{E ( s )} = {K}_{p} + \frac{{K}_{i}}{s} + {K}_{d} s$$

A transfer function of the closed loop feedback control is:

$${G}_{1} ( s ) = \frac{R ( s )}{Y ( s )} = \frac{{K}_{p} + \frac{{K}_{i}}{s} + {K}_{d} s}{H ( s )}$$

wherein H(s) is a feedback control function, Kₚ is a proportional constant, Kᵢ is an integration constant, and K_{d} is a differential constant.

During actual application of the closed ring control system, the proportion constant, the integration constant and the differential constant need to be calibrated according to the actual requirement. The embodiment provides a simple calibration method:

1. Determination of Kₚ

When the proportion constant Kₚ is determined, the integration constant and the differential constant of PID are removed firstly, that is, Kᵢ=K_{d}=0, and the PID is pure proportional regulation.

The input is set as 60% to 70% of the maximum allowed by the system, and the proportion gain P is gradually increased from 0 until the system oscillates.

Conversely, the proportion constant Kₚ at this time is gradually reduced until the system oscillation disappears, the proportion gain P at this time is recorded, Kₚ of the PID is set as 60% to 70% of the current value, and so far, Kₚ debugging is completed.

2. Determination of Kᵢ

After the proportion constant Kₚ is determined, a larger initial value of a integration constant Kᵢ is set, and then the Kᵢ is gradually reduced until the system oscillates. Conversely, the Kᵢ is gradually increased until the system oscillation disappears. The Kᵢ at this time is recorded, the integration constant Kᵢ of the PID is set as 150% to 180% of the current value, and so far, Kᵢ debugging is completed.

3. Determination of differential constant K_{d}

Generally, it is unnecessary to set the differential constant K_{d} which is just 0. If necessary, the setting method is as same as the method for determining Kₚ and Kᵢ, and the differential constant is set as 30% when there is no oscillation.

Step 5: whether a delay angle of the main spray timing is greater than zero is determined, if yes, Step 6 is performed, otherwise, Step 7 is performed;

Step 6: oil spraying map in the ECU is adjusted and then it is returned to Step 3, which is as follows:

if the delay angle of the main spray timing is greater than zero, the oil spraying map in the ECU is adjusted, and all the main spray timing in the oil spraying map is delayed according to the delay angle of the main spray timing; and

Step 7: self-adaptive oil spraying control is completed.

A specific calculation example is provided as follows:

by taking a certain type of biodiesel engine as an example, to implement the self-adaptive oil spraying control system and method for the biodiesel engine, pure diesel is added to the engine at first, and the engine operates stably to the working condition of idling to acquire a NOₓ emission standard value of the engine. By taking the biodiesel engine added with biodiesel in a certain ratio as an example (it is unnecessary to know the specific proportion of the biodiesel), after the engine operates stably to the working condition of idling, a NOₓ steady state emission discharge value is acquired in real time, and the main spray timing of the engine is subjected to self-adaptive adjustment by the closed ring control system. Parameters of the PID controller are calibrated according to the simple calibration mode, for example, the final calibration results of Kₚ, Kᵢ and K_{d} in this example are 4, 2 and 0.5, the system is stable after 1 s, and the main spray timing is delayed by 4° CA compared with the original engine.

After the main spray timing in the oil spraying map in the ECU is delayed by 4° CA, self-adaptive oil spraying control is completed. When the engine uses B20 biodiesel to operate under various working conditions, the NOₓ emission can be improved to varying degrees.

The above merely describes specific embodiments of the disclosure, but the protection scope of the disclosure is not limited thereto. Any person skilled in the art may easily conceive equivalent modifications or substitutions within the technical scope of the disclosure, and these modifications or substitutions shall fall within the protection scope of the disclosure. Therefore, the protection scope of the present invention should be determined with reference to the appended claims.

What is claimed is:

1. A self-adaptive oil spraying control system for a biodiesel engine, comprising an exhaust pipe, a gas sensor, a control module and an oil sprayer, wherein the exhaust pipe is connected to the oil sprayer; the gas sensor is mounted in the exhaust pipe; the gas sensor and the oil sprayer are connected to the control module respectively; and a self-adaptive oil spraying control program is embedded in the control module.

2. The self-adaptive oil spraying control system for the biodiesel engine according to claim 1, wherein there is a plurality of oil sprayers; and the plurality of oil sprayers are connected to the control module respectively.

3. The self-adaptive oil spraying control system for the biodiesel engine according to claim 1, wherein the gas sensor is a NOₓ sensor.

4. The self-adaptive oil spraying control system for the biodiesel engine according to claim 1, wherein the control module is a vehicle-mounted electronic control unit (ECU).

5. A self-adaptive oil spraying control method for a biodiesel engine applied to the oil spraying control system according to claim 1, comprising:
Step 1: acquiring a NOₓ emission standard value;
Step 2: acquiring a NOₓ steady state emission value in real time;
Step 3: determining whether the NOₓ steady emission value acquired in Step 2 is greater than the NOₓ emission standard value, if yes, performing Step 6, otherwise, performing Step 7;
Step 4: performing self-adaptive control on main spray timing according to a difference value between the NOₓ steady state emission value and the NOₓ emission standard value until the difference value between the NOₓ steady state emission value and the NOₓ emission standard value is zero, and then performing Step 5;
Step 5: determining whether a delay angle of the main spray timing is greater than zero, if yes, performing Step 6, otherwise, performing Step 7;
Step 6: adjusting oil spraying map in the ECU and then returning to Step 3; and
Step 7: completing self-adaptive oil spraying control.

6. The self-adaptive oil spraying control method for the biodiesel oil engine according to claim 5, wherein the Step 1 is as follows:
starting the engine added with pure diesel, controlling the engine to be stable under the working condition of idling, acquiring an output signal of a NOₓ sensor by the control module, and acquiring a NOₓ steady state emission value to serve as a NOₓ emission standard value.

7. The self-adaptive oil spraying control method for the biodiesel oil engine according to claim 5, wherein the Step 2 is as follows:
starting the engine added with biodiesel in any proportion, controlling the engine to be stable under the working condition of idling, acquiring an output signal of a NOₓ sensor by the control module, and acquiring a NOₓ steady state emission value in real time.

8. The self-adaptive oil spraying control method for the biodiesel oil engine according to claim 5, wherein the self-adaptive control in Step 4 is a closed loop feedback control.

9. The self-adaptive oil spraying control method for the biodiesel oil engine according to claim 8, wherein a transfer function of the closed loop feedback control is as follows:
$${G}_{1} ( s ) = \frac{R ( s )}{Y ( s )} = \frac{{K}_{p} + \frac{{K}_{i}}{s} + {K}_{d} s}{H ( s )}$$
H(s) being a feedback control function, Kₚ being a proportional constant, Kᵢ being an integration constant, and K_{d} being a differential constant.

10. The self-adaptive oil spraying control method for the biodiesel oil engine according to claim 5, wherein the Step 6 is as follows:
if the delay angle of the main spray timing is greater than zero, the oil spraying map in the ECU is adjusted, and all the main spray timing in the oil spraying map is delayed according to the delay angle of the main spray timing.
